(19) United States
(12) Patent Application Publication
(10) Pub. No.: US 2025/0105243 A1
(43) Pub. Date: Mar. 27, 2025

(54) Die Coater for Coating Electrode Slurry and Insulating Liquid

(71) Applicant: LG Energy Solution, Ltd., Seoul (KR)

(72) Inventor: Joon Sun Park, Daejeon (KR)

(73) Assignee: LG Energy Solution, Ltd., Seoul (KR)

(21) Appl. No.: 18/894,737

(22) Filed: Sep. 24, 2024

(30) Foreign Application Priority Data
Sep. 25, 2023 (KR) 10-2023-0127706

(51) Int. Cl. H01M 4/04; B05C 5/02

(52) U.S. Cl. CPC H01M 4/0411; B05C 5/0254

(57) ABSTRACT

A die coater includes a first block having an insulating liquid inlet and a second block on the first block. A shim assembly is interposed between the first block and the second block and configured to form a first slit and a second slit separated from each other. The first block includes a fixing portion having a fixing flow path therein that is a transfer path for insulating liquid flowed in through the insulating liquid inlet, and also includes a lip block configured to be coupled to and detachable from the fixing portion and being a front end of the first block. The lip block has an insulating liquid flow path that is connected to the fixing flow path, and is a transfer path for insulating liquid flowed in through the fixing flow path.

### CROSS-REFERENCE TO RELATED APPLICATIONS

This application claims priority under 35 U.S.C. § 119 (a) to Korean Patent Application No. 10-2023-0127706, which was filed on Sep. 25, 2023, and which is incorporated by reference herein.

### FIELD

The present disclosure relates to a die coater capable of simultaneously coating two different types of liquids on an electrode base material for a secondary battery.

### BACKGROUND

As the technology development and the demand for mobile devices increase, the demand for secondary batteries is also rapidly increasing. Among secondary batteries, lithium secondary batteries are widely used as energy sources for various electronic products as well as various mobile devices in terms of high energy density, a high operating voltage, and excellent storage and lifetime characteristics.

A lithium secondary battery employs an electrode in which an active material layer and an insulating layer are formed on a surface of a current collector. The electrode is manufactured using a coating device such as a die coater such that both of an electrode slurry containing an active material and an insulating liquid containing an insulating material, etc. are applied onto the surface of the current collector to overlap a portion of a corner of an electrode mixture layer and then dried.

A die coater 1 includes a first block 2 and a second block 2′, a shim assembly 3 is interposed between the first block 2 and second block 2′, an electrode slurry is discharged through a first slit 4, and an insulating liquid is discharged through a second slit 5.

The first block 2 comprises an insulating liquid flow path 7, which serves as a transfer path for insulating liquid flowed in through the insulating liquid inlet 6. Such insulating liquid flow path 7 is a structure extending in a direction perpendicular to a plane of the shim assembly 3 ((X direction). One side end of the insulating liquid flow path 7 is connected with the one side end of the flow path (not shown) of the shim assembly 3, and the other side end of the flow path of the shim assembly 3 is connected with the second slit 5. Accordingly, the insulating liquid is discharged through the second slit 5 via the insulating liquid inlet 6, the insulating liquid flow path 7 of the first block 2, and the flow path (not shown) of the shim assembly 3 in sequence.

In such a conventional die coater 1, the position at which the insulating liquid is discharged is fixed, so that only electrodes of a single pattern can be produced. In other words, when the coating position of the insulating liquid is changed along the width direction (Y direction), such that the position of the second slit 5 is also changed, a die coater with a changed position of the insulating liquid transfer path has to be newly manufactured in response thereto, which is a problem due to the inconvenience and increased cost of newly manufacturing the die coater.

Therefore, it is necessary to develop a technology for a die coater that can respond to a change in the coating position of an insulating liquid.

### SUMMARY

### Technical Problem

The present disclosure is directed to providing a die coater capable of responding to a case where a coating position of an insulating liquid is changed.

### Technical Solution

The present disclosure relates to a die coater capable of effectively and simultaneously coating two different types of liquids on an electrode base material for a secondary battery, wherein the die coater including a first block having an insulating liquid inlet and a second block on the first block; and a shim assembly interposed between the first block and the second block and configured to form a first slit and a second slit separated from each other; wherein the first block includes a fixing portion having a fixing flow path therein that is a transfer path for insulating liquid flowed in through the insulating liquid inlet; and a lip block configured to be coupled to and detachable from the fixing portion and being a front end of the first block, the lip block having an insulating liquid flow path that is connected to the fixing flow path and is a transfer path for insulating liquid flowed in through the fixing flow path.

In one aspect, the insulating liquid flow path includes a first insulating liquid flow path, one end of which is connected to the fixing flow path and extending in a direction perpendicular to the extension direction of the fixing flow path (Y direction); and a second insulating liquid flow path connected to the other end of the first insulating liquid flow path and extending in a direction parallel to the fixing flow path (X direction).

In one aspect, the fixing flow path extends in a direction (X direction) from an upper portion of the die coater to a lower portion of the die coater.

In one aspect, any one of the first block and the second block is provided with a manifold accommodating an electrode slurry.

In one aspect, the shim assembly includes a body shim forming the first slit for discharging electrode slurry; and a sub shim forming the second slit for discharging the insulating liquid.

In one aspect, The body shim and the sub shim have the same height and do not overlap top and bottom to be located on the same plane between the first block and the second block.

In one aspect, a height of the first slit corresponds to a height of the body shim, and a height of the second slit is smaller than a height of the sub shim.

In one aspect, the sub shim comprises a concave flow path that is open toward the first block and has a bottom surface.

In one aspect, the sub shim comprises a flow path that penetrates in the thickness direction of the sub shim.

In one aspect, the sub shim comprises a flow path therein.

In one aspect, a closed end of the flow path of the sub shim is connected to an insulating liquid flow path of the lip block, and an open end of the flow path forms the second slit.

In one aspect, the body shim includes a base extending along a width direction (Y direction); and first and second guides protruding and extending from both ends of the base, respectively.

In one aspect, the sub shims are two or more.

In one aspect, the sub shim is coupled to the first block.

In one aspect, the sub shim is coupled to a lip block of the first block.

In one aspect, the body shim is coupled to the first block and the second block.

In one aspect, the body shim does not cover the manifold.

In one aspect, several kinds of lip blocks having paired insulating liquid flow paths formed according to a position of the second slit are provided, thereby the lip blocks are configured to be replaced in response to a change in position of the second slit.

In one aspect, the lip block is provided in various types with different lengths in the width direction of the first insulating liquid flow path.

### Advantageous Effects

The die coater according to the present disclosure can respond to a change in the coating pattern through replacement of the lip block, thereby the overall die coater is not required to be newly manufactured when a coating pattern is changed, thereby reducing the increase in effort and cost due to newly manufacture of the die coater.

In accordance with a die coater of the present disclosure, wherein the first block includes a fixing portion and a lip block configured to be coupled to and detachable from the fixing portion, the lip block is provided with an insulating liquid flow path, but there are several types of lip blocks having an insulating liquid flow path formed by paired according to the position of the second slit through which the insulating liquid is discharged, so that in case the position of the second slit is changed, the die coater can respond to a change in the coating pattern by replacing the lip block having an insulating liquid flow path suitable for flowing in the insulating liquid into the second slit.

The die coater according to the present disclosure is configured to discharge an electrode slurry and an insulating liquid simultaneously, thereby effectively coating two different types of liquid on an electrode base material.

### DESCRIPTION OF THE DRAWINGS

FIG. 1 is a drawing illustrating a die coater according to the related art.

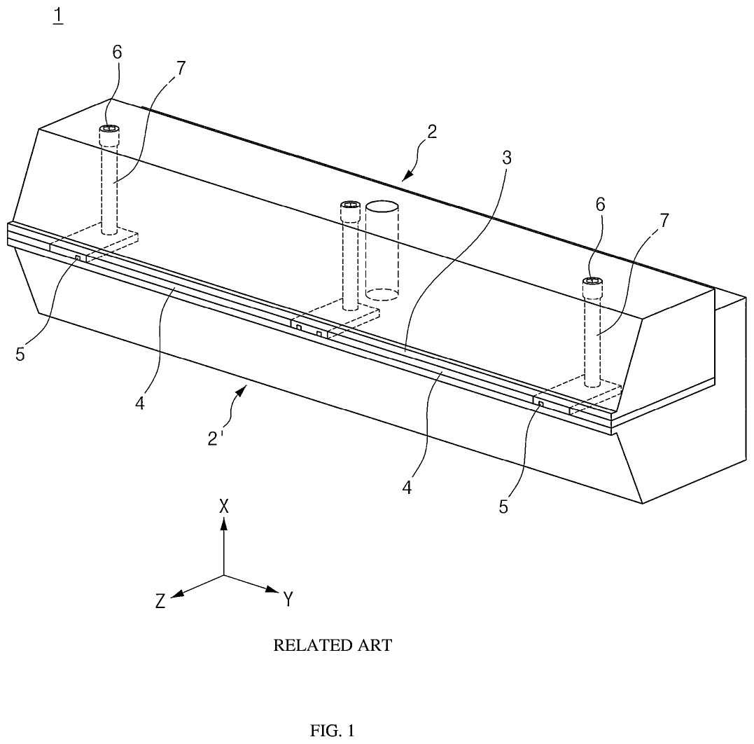

FIG. 2 is an exploded perspective view illustrating a die coater according to one aspect of the present disclosure.

FIG. 3 is an enlarged view of a portion of FIG. 2.

FIG. 4 is a plane view illustrating a die coater looking through the first block.

FIG. 5 is an enlarged front view illustrating part A of FIG. 4.

FIG. 6 is a front view and a perspective view of a sub shim according to one aspect of the present disclosure.

FIG. 7 is an exploded perspective view illustrating a die coater according to another aspect of the present disclosure.

FIG. 8 is a perspective view of the sub shim illustrated in FIG. 7.

FIG. 9 is a front view and perspective view of a sub shim according to one aspect of the present disclosure.

FIG. 10 is a front view and perspective view of a sub shim according to one aspect of the present disclosure.

### DETAILED DESCRIPTION

Hereinafter, the present disclosure will be described in detail with reference to the drawings. Prior to this, terms and words used in the present specification and claims should not be construed as limited to general or dictionary terms and should be interpreted with the meaning and concept in accordance with the technical idea of the present disclosure based on the principle that the inventors have appropriately defined the concepts of terms in order to explain the invention in the best way.

Accordingly, it is to be understood that the embodiments described herein, and the configurations illustrated in the drawings are only the most preferred embodiments of the present disclosure and are not intended to be representative of all of the technical ideas of the present disclosure, and that there may be various equivalents and modifications that may be substituted for them at the time of filing.

In addition, in describing the present disclosure, specific descriptions of related disclosed configurations or functions are omitted where it is considered that such detailed descriptions would obscure the subject matter of the present disclosure.

The present disclosure is shown in embodiment to more fully explain the present disclosure to those of ordinary skill in the art, and therefore, the shapes and sizes of the components in the drawings may be exaggerated, omitted, or shown schematically for clarity. Accordingly, the size or proportions of each component are not necessarily indicative of its actual size or proportions.

Aspect of the present disclosure relates to a die coater capable of effectively and simultaneously coating two different types of liquids on an electrode base material of an electrode for a secondary battery.

In one example, a die coater of an aspect of the present disclosure includes a first block having an insulating liquid inlet, a second block coupling to the first block, and a shim assembly interposed between the first block and the second block to form a first slit and a second slit separated from each other.

In exemplary aspects, the first block includes: a fixing portion having a fixing flow path therein that becomes a transfer path for an insulating liquid flowed in through the insulating liquid inlet; and a lip block configured to be coupled to and detachable from the fixing portion and being a front end of the first block. In addition, the lip block comprises an insulating liquid flow path connected to the fixing flow path and being a transfer path for insulating liquid flowed in through the fixing flow path. The lip block is provided with several kinds of lip blocks having paired insulating liquid flow paths formed according to a position of the second slit, which the insulating liquid is discharged, and is configured to replace the lip block in response to a change in the position of the second slit.

Accordingly, even if the position of the second slit is changed due to a change in the coating pattern of the electrode, it can correspond to the change in the coating pattern by selecting a lip block paired with the position changed second slit and coupling it to the fixing portion. Therefore, solving the inconvenience and reducing the cost due to newly manufacturing the overall die coater.

The die coater of an aspect of the present disclosure may include a shim assembly including a body shim and a sub shim. The body shim forms a first slit for discharging an electrode slurry, and the sub shim forms a second slit for discharging an insulating liquid supplied through an insulating liquid inlet of the lip block. In particular, the body shim and the sub shim have the same height and do not overlap top and bottom, and accordingly, the body shim and the sub shim are located on the same plane between the first block and the second block.

In one aspect, the sub shim may be configured for coupling to and detachable from the body shim. In another aspect, the sub shim and the body shim may be integrally formed.

According to the die coater of an aspect of the present disclosure, it is configured to discharge two different types of liquid, such as an electrode slurry and an insulating liquid, simultaneously, and in particular, the first slit and the second slit discharging the electrode slurry and the insulating liquid, respectively, are physically separated from each other in the die coater, thereby internal mixing of the electrode slurry and the insulating liquid can be prevented.

Hereinafter, some aspects of a die coater according to the present disclosure will be described in detail with reference to the accompanying drawings.

### First Aspect

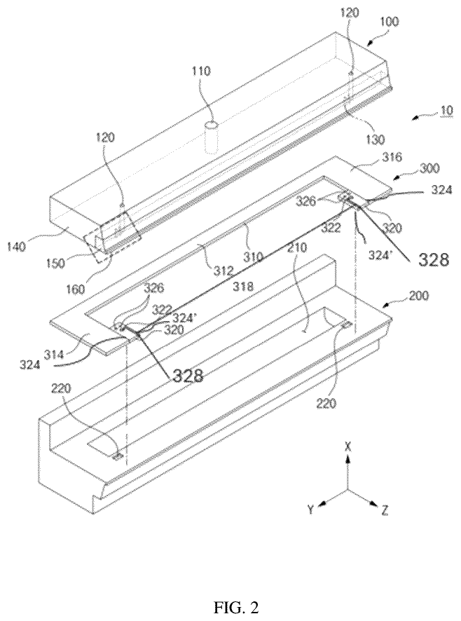

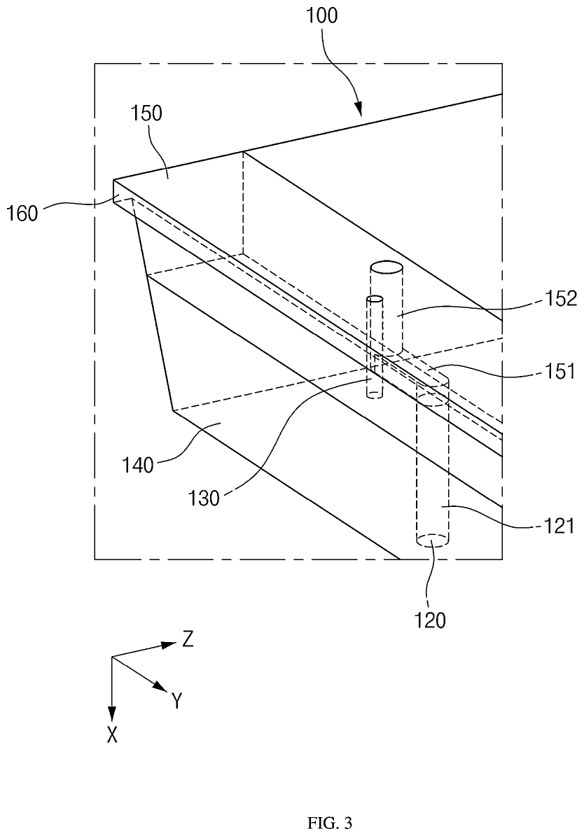

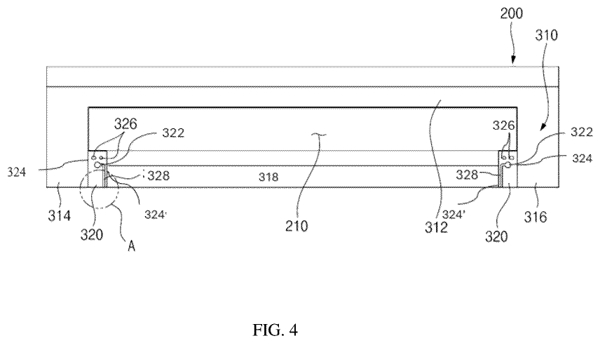

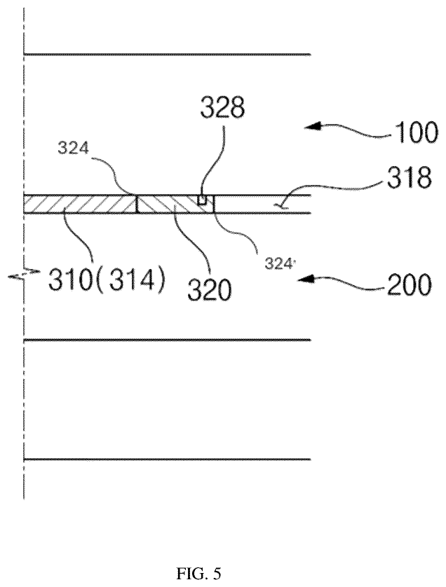

FIG. 2 is an exploded perspective view illustrating a die coater according to one aspect of the present disclosure, FIG. 3 is an enlarged view of a portion of FIG. 2, FIG. 4 is a plane view illustrating a die coater looking through the first block, and FIG. 5 is an enlarged front view illustrating part A of FIG. 4.

Referring to FIG. 2, the overall configuration of a die coater 10 according to an aspect of the present disclosure will be described.

As described above, aspects of the present disclosure relate to a die coater 10 capable of effectively and simultaneously coating two different types of liquids on a current collector for a secondary battery. The two different types of liquid may be, for example, an electrode slurry and an insulating liquid.

The die coater 10 of aspects of the present disclosure includes a first block 100 and a second block 200, and a shim assembly 300 interposed therebetween. In particular, the shim assembly 300 in an aspect of the present disclosure includes a body shim 310 and one or two or more sub shims 320.

In one aspect, the sub shim 320 may be configured for coupling to and detachable from the body shim 310. In another aspect, the sub shim 320 and the body shim 310 may be integrally formed.

The first block 100 is a portion comprising approximately half of the body of the die coater 10, which comprises an insulating liquid inlet 120. The second block 200 is the portion occupying the other half of the body coupling to the first block 100, and in some aspects, the second block 200 may comprise a manifold 210 for accommodating an electrode slurry. Although FIG. 2 illustrates an aspect in which the manifold 210 is provided in the second block 200, the manifold 210 may be formed in the first block 100; in other words, the manifold 210 for accommodating the electrode slurry may be provided in any one of the first block 100 and the second block 200.

For reference, FIG. 2 illustrates an electrode slurry inlet 110 in connected to the manifold 210 of the second block 200 formed in the first block 100, although the electrode slurry inlet 110 may also be formed in the second block 200. On the other hand, the insulating liquid inlet 120 has to be formed only in the first block 100, because the layout design is limited by the flow path 322 formed in the sub shim 320 and the airtight structure, which will be described later.

Referring to FIG. 2 and FIG. 3, the first block 100 includes a fixing portion 140 and a lip block 150, wherein the lip block 150 is configured for coupling to and detachable from the fixing portion 140. The lip block 150 includes a lip 160 as a front end portion of the first block 100. The lip 160 serves to generate shear between the front end of the die coater 10 and the backup roll (not shown), thereby smoothing the electrode slurry and insulating liquid.

The fixing portion 140 has a fixing flow path 121 that serves as a transfer path for the insulating liquid flowed in through the insulating liquid inlet 120. The fixing flow path 121 is formed in the inside of the fixing portion 140 and has a hollow internal space suitable for the insulating liquid to be transferred. The fixing flow path 121 extends in a direction (X direction) from the upper portion of the die coater to the lower portion of the die coater. One end of the fixing flow path 121 is connected with the insulating liquid inlet 120, and the other end of the fixing flow path 121 is connected with the first insulating liquid flow path 151.

The lip block 150, which is configured for coupling to and detachable from the fixing portion 140, also has insulating liquid flow paths 151,152 that serve as transfer paths for the insulating liquid. The insulating liquid flow paths 151,152 are formed in the inside of the lip block 150 and have a hollow internal space suitable for the insulating liquid to be transferred. The insulating liquid flow paths 151,152 are connected to the fixing flow path 121. Thus, the insulating liquid flowed in through the insulating liquid inlet 120 of the first block 100 is discharged sequentially through the fixing flow path 121 of the fixing portion 140 and the insulating liquid flow path 151,152 of the lip block 150, and finally discharged through the second slit 328.

The lip block 150 comprising the first block 100 may be provided with several types of lip blocks 150 having paired insulating liquid flow paths formed according to the position of the second slit 328 through which the insulating liquid is discharged. When the coating pattern of the electrode is changed, it is general that the portion where the insulating liquid is applied changes its position along the width direction. Accordingly, the second slit 328 of the die coater changes the position along the width direction (Y direction) of the die coater 10. Meanwhile, since the insulating liquid inlet 120 and the fixing flow path 121 of the first block 100 are fixed, an inside of the lip block 150 according to an aspect of the present disclosure is provided with a lip block 150 having an insulating liquid flow path in which the one side end is connected with the fixing flow path 121 and the other side end is connected with the second slit 328, and several kinds of lip blocks having a paired insulating liquid flow path for each of the positions of the second slit are provided.

Accordingly, when the position of the second slit 328, which the insulating liquid is discharged, is changed due to a change in the coating pattern of the insulating liquid, the operator can select a lip block 150 that is paired with the second slit that has changed position among the several kinds of lip blocks 150, and correspond to the change in the coating pattern of the insulating liquid by replacing the lip block 150.

The insulating liquid flow paths provided in the lip block 150 include a first insulating liquid flow path 151 and a second insulating liquid flow path 152. One end of the first insulating liquid flow path 151 is connected with the fixing flow path 121 provided in the fixing portion 140 to flow in the insulating liquid flowed in the fixing flow path 121 into the lip block 150. Further, the first insulating liquid flow path 151 extends in a direction perpendicular to the extension direction of the fixing flow path 121 in order to respond when the second slit 328 changes position along the width direction (Y direction).

In one aspect, the lip block 150 is provided in various types with different lengths in the width direction of the first insulating liquid flow path 151. When the electrode coating pattern is changed, the sub shim 320 forming the second slit 328 changes the position along the width direction (Y direction) of the die coater. As explained with reference to FIGS. 2 and 3, when the sub shim 320 is moved in the direction of the outer side of the die coater 10 along the width direction (Y direction), it becomes distant from the insulating liquid inlet 120. According to the present disclosure, among various types of lip blocks 150, a lip block 150 having the first insulating liquid flow path 151 having a width direction length corresponding to the width direction length from the insulating liquid inlet 120 to the sub shim 320 can be selected in response to a change in the position of the sub shim.

One end of the second insulating liquid flow path 152 is connected with the other end of the first insulating liquid flow path 151 and extending in a direction parallel to the fixing flow path 121 (X direction). In addition, the other end of the second insulating liquid flow path 152 is connected with the second slit 328. Therefore, the insulating liquid flowed in the lip block 150 can be discharged to the outside through the second slit 328 via the first insulating liquid flow path 151, the second insulating liquid flow path 152.

The shim assembly 300 is interposed between the first block 100 and the second block 200, wherein the shim assembly 300 is basically interposed between the first block 100 and the second block 200 to form a slit at a height suitable for discharging the electrode slurry and insulating liquid. In addition, the shim assembly 300 serves to limit the flow direction of the electrode slurry and insulating liquid flowed in or accommodated in the die coater 10 so that it is discharged toward the slit without flowing backward, and further serves to seal the electrode slurry and insulating liquid from leaking into any part of the die coater 10 except the slit.

Referring to FIGS. 2 and 4 to 5, the shim assembly 300 includes a body shim 310 and a sub shim 320, which form a first slit 318 and a second slit 328 separated from each other. Specifically, the body shim 310 forms the first slit 318 for discharging an electrode slurry accommodated in the manifold 210 of the second block 200, and the sub shim 320 forms the second slit 328 for discharging an insulating liquid supplied through the first block 100.

Moreover, the body shim 310 and the sub shim 320 have the same height, and they do not overlap top and bottom; thus, the body shim 310 and the sub shim 320 are located on the same plane between the first block 100 and the second block 200.

Referring to FIG. 2, the body shim 310 includes a base 312 extending along the width direction (Y direction), and a first guide 314 and a second guide 316 protruding and extending from both ends of the base 312, respectively. The first guide 314 and the second guide 316 are spaced apart from each other in the width direction (Y direction) with the manifold 210 between them, and the first guide 314 and the second guide 316 may each be disposed so as not to cover the manifold 210. The first guide 314 and the second guide 316 may each have a rectangular shape having a uniform width along the width direction (Y direction). A body shim 310 is coupled to the first block 100 and the second block 200. The body shim 310 may be coupled to the first block 100 and the second block 200 by fixing pins, fixing bolts, or both, and the body shim 310 may be provided with coupling holes into which they may be inserted.

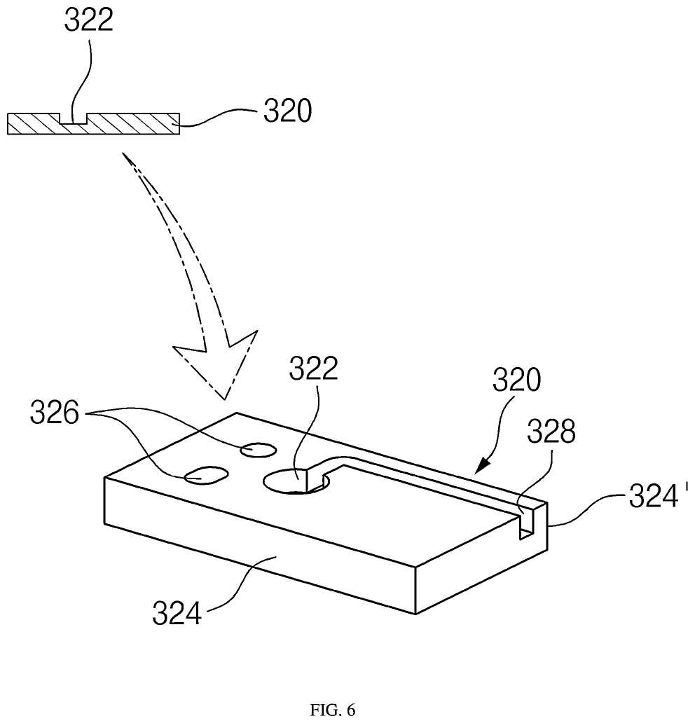

Referring to FIG. 2 and FIG. 6, the sub shim 320 is open toward the first block 100 and comprises a concave flow path 322 with a bottom surface.

Here, the body shim 310 forms a first slit 318 in the space between the first and second guides 314, 316, and the open end of the concave flow path 322 having a bottom surface form a second slit 328 in the sub shim 320. The depth of the flow path 322 is smaller than the thickness (height) of the sub shim 320, so that eventually, as shown in FIG. 5, the height of the first slit 318 corresponds to the height of the body shim 310 and the height of the second slit 328 is formed smaller than the height of the sub shim 320.

Moreover, since the body shim 310 and the sub shim 320 have the same height and located on the same plane without overlapping top and bottom, the width of the first slit 318 is limited as much as the width of the sub shim 320.

For example, in the first aspect illustrated in FIG. 2, one sidewall 324 of the paired sub shims 320 is adhered to an inside wall of the first guide 314 and the second guide 316, respectively (See FIG. 4). Accordingly, the distance between the facing sidewalls 324′ of the paired sub shims 320 (opposite sides of the adhered sidewalls) corresponds to the substantial width of the first slit 318; in other words, the length of the distance between the inside walls of the first guide 314 and the second guide 316 minus the width of the sub shim 320 becomes the width of the first slit 318.

As such, considering the structure of the second slit 328 formed by the sub shim 320, it is blocked from the electrode slurry of the first slit 318 by the two sidewalls 324, 324′ of the sub shim 320. Further, since the lower side of the flow path 322 is a bottom surface and the upper side is adhered to the first block 100, the sub shim 320 is structurally completely isolated from the electrode slurry. Thus, the die coater 10 according to an aspect of the present disclosure is significantly less likely to have two different kinds of liquids mixed inside.

Referring to FIG. 2, FIG. 4, and FIG. 6, the closed end of the concave flow path 322 formed in the sub shim 320 is connected to the insulating liquid flow path 151,152 of the lip block 150 to receive insulating liquid. Specifically, the insulating liquid supplied from the insulating liquid inlet 120 of the first block 100 is supplied to the flow path 322 of the sub shim 320 by sequentially passing through the fixing flow path 121 of the fixing portion 140, the first insulating liquid flow path 151 of the lip block 150, and the second insulating liquid flow path 152. For reference, as shown in FIG. 2, the number and position of the insulating liquid inlets 120 correspond to the number and position of the sub shims 320.

In addition, the sub shim 320 may be coupled to the first block 100. The sub shim 320 may be coupled to any one of the fixing portion 140 and the lip block 150 of the first block 100. In the first aspect illustrated in FIG. 2, the sub shim 320 is coupled to the lip block 150 of the first block 100. The sub shim 320 may be fixed to the first block 100 with a pin member 130 inserted into a coupling hole 326 provided in the sub shim 320. The position of the sub shim 320 is fixed by the pin member 130. The pin member 130 may be disposed parallel to the second insulating liquid flow path 152 of the lip block 150 or may protrude around the fixing flow path 121 of the fixing portion 140.

Here, the pin member 130 and the coupling hole 326 are preferably designed such that the fixed position and direction of the sub shim 320 is uniformly determined. Specifically, the sub shim 320 should not rotate when inserted into the pin member 130 to ensure that the installation direction is uniformly determined, which may be accomplished by designing the pin member 130 in a plurality, forming the pin member 130 and the coupling hole 326 in a shape other than a circular cross-section, or a combination of these structures. Further, if necessary, the second block 200 may be provided with a concave pin insertion hole 220 to accommodate the protruding pin member 130.

### Second Aspect

The second aspect of the present disclosure is an aspect suitable for applying two or more rows of electrode slurry and insulating liquid, respectively, on the current collector, which is an electrode base material, and then a slitting process is performed.

In other words, the second aspect is an aspect suitable for simultaneously applying active material coatings to have a structure of “insulating liquid-electrode slurry-insulating liquid” in two or more rows on the current collector.

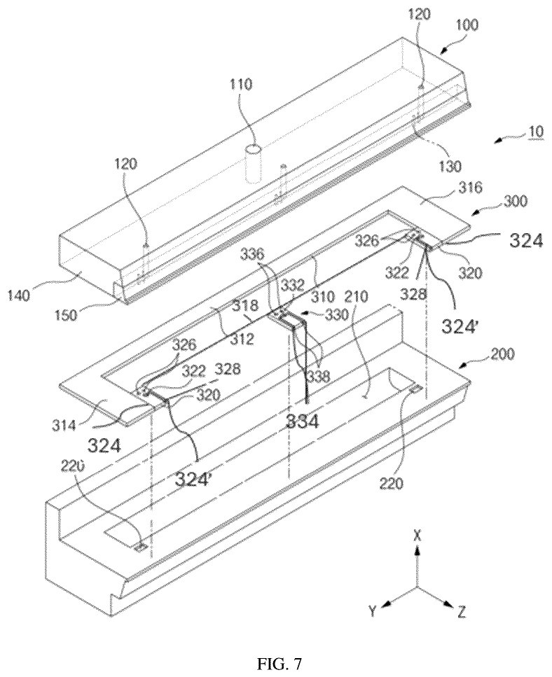

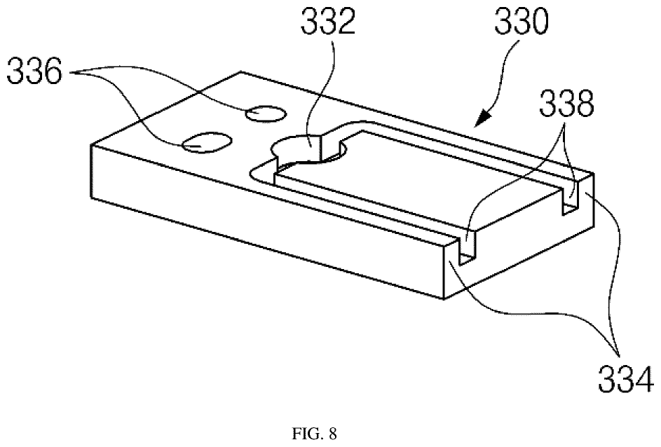

FIG. 7 is an exploded perspective view illustrating a die coater according to another aspect of the present disclosure, and FIG. 8 is a perspective view of the second sub shim 330 illustrated in FIG. 7.

Referring to these drawings, the second aspect includes the structure of the first aspect described above, but further includes a second sub shim 330. The second sub shim 330 is installed in the middle of the width direction of the die coater 10 (Y direction). In some aspects, the second sub shim 330 discharges insulating liquid in two streams through a U-shaped flow path 332. In other words, the second sub shim 330 is configured to discharge insulating liquid in two streams corresponding to each of the sub shims 320 on both sides adhered and disposed to the first and second guides 314, 316.

In addition, a second sub shim 330 is disposed between the first and second guides 314, 316 of the body shim 310, and in the same manner that the aforementioned sub shims 320 limit the substantial width of the first slit 318, the second sub shim 330 also functions as a limiting element of the first slit 318. Thus, the second sub shim 330, disposed in the middle of the first slit 318, splits the insulating liquid into two streams, thereby causing the electrode slurry to be discharged in two parallel rows. The height of the second sub shim 330 corresponds to the height of the sub shims 320.

According to such disposition of the second sub shim 330 and the two-row discharge structure of the insulating liquid, the application structure of “insulating liquid-electrode slurry—insulating liquid” on the current collector is formed in two rows parallel according to the length direction of the current collector, and two current collector rolls can be obtained by performing a slitting process to cut the middle of the two parallel rows.

Referring to FIG. 8, the second sub shim 330 has the same configuration as the sub shim 320 except for the structure of the U-shaped flow path 332. Specifically, the second sub shim 330 has a concave U-shaped flow path 332 that is open toward the first block 100 and has a bottom surface. The closed end of the U-shaped flow path 332 is connected to the insulating liquid flow path of the lip block 150, and the two open ends of the U-shaped flow path 332 form a third slit 338. Similarly, the position of the second sub shim 330 is fixed such that the coupling hole 336 is engaged in the pin member 130 and does not rotate.

Here, in the second aspect, although it is described that the electrode slurry and the insulating liquid are simultaneously applied in two rows in parallel by adding the second sub shim 330, it can be obviously understood by those skilled in the art that two or more second sub shims 330 may be added and thus applying in three or more rows.

### Third Aspect

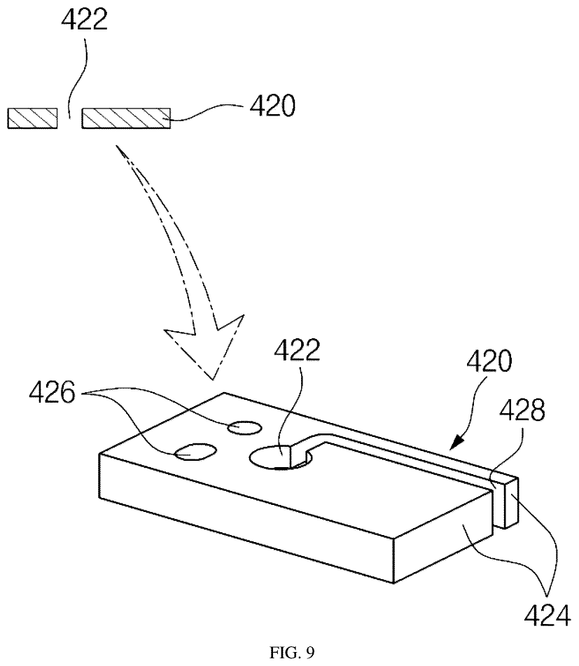

FIG. 9 is a front view and perspective view of a sub shim according to one aspect of the present disclosure, and the sub shim of FIG. 9 will be described, with focusing on the differences from the sub shim 320 described with reference to FIG. 6.

Referring to FIG. 9, the sub shim 420 comprises a flow path 422 that penetrates in the thickness direction of the sub shim 420. Compared to the aspect illustrated in FIG. 6, the flow path 422 is open in the direction toward the first block and is also open in the direction toward the second block. A closed end of the flow path 422 is connected to an insulating liquid flow path 152 of the lip block 150 to receive insulating liquid, and an open end of the flow path 422 forms a second slit 428. The depth of the flow path 422 and the height of the second slit 428 are each the same as the thickness of the sub shim 420.

### Fourth Aspect

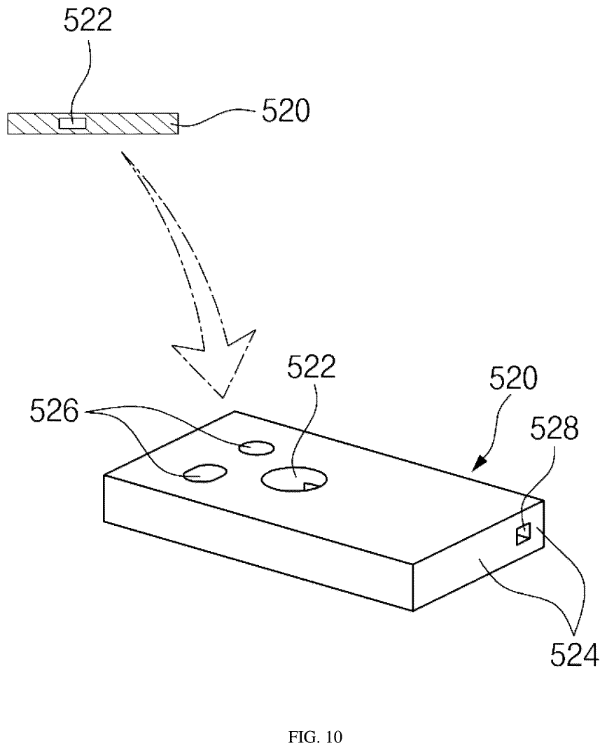

FIG. 10 is a front view and perspective view of a sub shim according to one aspect of the present disclosure, and the sub shim of FIG. 10 will be described, with focusing on the differences from the sub shim 320 described with reference to FIG. 6.

Referring to FIG. 10, the sub shim 520 has a flow path 522 therein. Compared to the aspect shown in FIG. 6, the flow path 522 is not open in the direction toward the first block. The closed end of the flow path 522 is connected with the insulating liquid flow path 152 of the lip block 150 to receive insulating liquid, and the open end of the flow path 522 forms a second slit 528. A height of the second slit 528 is formed smaller than a thickness of the sub shim 520.

As described above, the present invention has been described in more detail with reference to the accompanying drawings and the embodiments. Therefore, the configurations described herein or shown in the drawings are merely one embodiment of the present invention and do not represent all the technical spirit of the present invention such that it should be understood that there may be various equivalents and modifications capable of substituting the embodiments and the configurations at the time of filing the present application.

### DESCRIPTION OF REFERENCE NUMERALS

10: die coater
100: first block
200: second block
110: electrode slurry inlet 1
120: insulating liquid inlet
121: fixing flow path
130: pin member
140: fixing portion
150: lip block
160: lip
151: first insulating liquid flow path
152: second insulating liquid flow path
210: manifold
220: pin insertion hole
300: shim assembly
310: body shim
320, 420, 520: sub shim(s)
312: base
314: first guide
316: second guide
318: first slit
322, 422, 522: flow path
(324 and 324′), 334, 424, 524: sidewall(s)
326, 336 426, 526: coupling hole(s)
328, 428, 528: second slit
330: second sub shim
332: U-shaped flow path
338: third slit

1. A die coater comprising:
a first block having an insulating liquid inlet and a second block on the first block; and
a shim assembly interposed between the first block and the second block and configured to form a first slit and a second slit separated from each other;
wherein the first block comprises:
a fixing portion having a fixing flow path therein that is configured to transfer an insulating liquid flowed in through the insulating liquid inlet; and
a lip block configured to be coupled to and detachable from the fixing portion and being a front end of the first block,
wherein the lip block has an insulating liquid flow path that is connected to the fixing flow path and is configured to transfer an insulating liquid flowed in through the fixing flow path.

2. The die coater of claim 1, wherein the insulating liquid flow path comprises:
a first insulating liquid flow path part, one end of which is connected to the fixing flow path and extending in a direction perpendicular to the extension direction of the fixing flow path; and
a second insulating liquid flow path part connected to the other end of the first insulating liquid flow path part and extending in a direction parallel to the fixing flow path.

3. The die coater of claim 1, wherein the fixing flow path extends in a direction from an upper portion of the die coater to a lower portion of the die coater.

4. The die coater of claim 1, wherein any one of the first block and the second block comprises a manifold configured to accommodate an electrode slurry.

5. The die coater of claim 1, wherein the shim assembly comprises a body shim forming the first slit, which is configured to discharge an electrode slurry, and a sub shim forming the second slit, which is configured to discharge an insulating liquid.

6. The die coater of claim 5, wherein the body shim and the sub shim have the same height and do not overlap top and bottom to be located on the same plane between the first block and the second block.

7. The die coater of claim 5, wherein a height of the first slit corresponds to a height of the body shim, and a height of the second slit is smaller than a height of the sub shim.

8. The die coater of claim 5, wherein the sub shim comprises a concave flow path that is open toward the first block and has a bottom surface.

9. The die coater of claim 5, wherein the sub shim comprises a flow path that penetrates in the thickness direction of the sub shim.

10. The die coater of claim 5, wherein the sub shim comprises a flow path therein, such that the flow path is not open in a direction toward the first block.

11. The die coater of claim 1, comprising at least one other different lip block configured to be coupled to and detachable from the fixing portion, being a front end of the first block, and having paired insulating liquid flow paths formed according to a position of the second slit, thereby the lip blocks are configured to be replaced in response to a change in position of the second slit.

12. The die coater of claim 8, wherein a closed end of the flow path is connected to an insulating liquid flow path of the lip block, and an open end of the flow path forms the second slit.

13. The die coater of claim 5, wherein the body shim comprises:
a base extending along a width direction; and
first and second guides protruding and extending from opposite ends of the base, respectively.

14. The die coater of claim 5, comprising two or more sub shims.

15. The die coater of claim 5, wherein the sub shim is coupled to the first block.

16. The die coater of claim 5, wherein the sub shim is coupled to a lip block of the first block.

17. The die coater of claim 5, wherein the body shim is coupled to the first block and the second block.

18. The die coater of claim 5, wherein any one of the first block and the second block comprises a manifold configured to accommodate an electrode slurry, and the body shim does not cover the manifold

19. The die coater of claim 2, comprising at least one other lip block configured to be coupled to and detachable from the fixing portion and being a front end of the first block, the lip blocks having different lengths in the width direction of the first insulating liquid flow path.

20. The die coater of claim 9, wherein a closed end of the flow path is connected to an insulating liquid flow path of the lip block, and an open end of the flow path forms the second slit.
